(19) United States
(12) Patent Application Publication
(10) Pub. No.: US 2002/0116214 A1
(43) Pub. Date: Aug. 22, 2002

(54) Automated fundraising accounting system

(76) Inventor: James Van Horn, Center Valley, PA (US)

Correspondence Address: Raymond N. Scott, Jr., WOODCOCK WASHBURN LLP, One Liberty Place - 46th Floor, Philadelphia, PA, 19103, US

(21) Appl. No.: 10/074,819

(22) Filed: Feb. 13, 2002

Related U.S. Application Data
(60) Provisional application No. 60/269,233, filed on Feb. 16, 2001.

(51) Int. Cl. G06F 17/60

(52) U.S. Cl. 705/1

(57) ABSTRACT

A purchaser selects a beneficiary and merchant predefines a donation percentage. The selected beneficiary and the predefined donation percentage are received by a processor. The purchaser's transaction amount is tracked, the predefined donation percentage of the transaction amount (i.e., the donation amount) is donated from the merchant to the beneficiary. Optionally, electronic fund transfer is used to transfer the donation amount from a bank account of the merchant to a bank account of the beneficiary.

### FIELD OF THE INVENTION

The invention generally relates to the field of charitable fundraising and, more particularly, the invention relates to systems and methods for automated fundraising accounting.

### BACKGROUND OF THE INVENTION

Philanthropy and charitable giving in the United States has reached an annual level of over $190 billion. Most of this funding is from corporations, foundations, and estates that focus on higher education, health care, and support of individual religions. Elementary and secondary schools and other non-profit organizations often receive less funding than higher education and health care. As a result, some schools and organizations have turned to fund raising projects, such as product sales and charitable events, to supplement their budgets. Traditional product sales and charitable events often distract students, teachers, and parents from their primary tasks and on occasion have even resulted in a financial loss. Such fundraising efforts may become a significant time and resource burden.

In recent years, schools have used paper scrip (i.e., a discounted retail merchant gift certificate) as a method of fundraising. This method is based on a school buying a volume of gift certificates from a particular merchant at a discounted price with the intent to sell them at full face value. The discount becomes the profit for the school. There are several companies using such a paper scrip fundraising method including National Scrip and Great Lakes Scrip.

While the paper scrip method has raised several million dollars for participating schools over the years, the method is cumbersome for all parties involved. It is inconvenient for purchasers of paper scrip and very limited in its ability to maximize the participation and return on spending with merchants. The school pays for the paper scrip in advance at a select group of merchants hoping that they have purchased the correct amount and denominations to meet the needs of the purchasers. Purchasers go to the school and purchase paper scrip prior to shopping, thereby adding more time to a shopping trip. Purchasers determine in advance their anticipated spending for each merchant but may not accurately predict how much they will spend. Any amount spent with cash rather than with paper scrip, does not result in a donation. Finally, merchants manually record each certificate and audit the system, school by school, church by church, etc.

Therefore, there is a need for an improved automated fundraising accounting system and method that overcomes these limitations.

### SUMMARY OF THE INVENTION

The invention is directed to a system and method wherein a purchaser selects a beneficiary and a merchant predefines a donation percentage. The selected beneficiary and the predefined donation percentage are received by a processor, for example. The purchaser's transaction amount is tracked and the predefined donation percentage of the transaction amount (i.e., the donation amount) is donated from the merchant to the beneficiary.

A transaction purchase amount is received and a donation amount is determined based on the received transaction purchase amount and a predefined donation percentage. The determined donation amount is credited to an account of a beneficiary. The donation amount may be electronically transferred from the merchant account to the beneficiary account.

A merchant is contracted with and the merchant agrees to donate a predefined percentage of transaction proceeds. An identification of the merchant and the predefined percentage is stored to a data store.

A purchaser is contracted with and the purchaser selects a beneficiary for receiving at least a portion of the merchant donation. An identification of the purchaser and an identification of the selected beneficiary is stored to a data store.

The above-listed features, as well as other features, of the invention will be more fully set forth hereinafter.

### BRIEF DESCRIPTION OF THE DRAWINGS

The invention is further described in the detailed description that follows, by reference to the noted plurality of drawings by way of non-limiting illustrative embodiments of the invention, in which like reference numerals represent similar elements throughout the several views of the drawings, and wherein:

FIG. 1 is a block diagram of an illustrative fundraising accounting system in accordance with an embodiment of the invention;

FIG. 2a is a flow diagram of an illustrative method for contracting with a merchant, in accordance with an embodiment of the invention;

FIG. 2b is a diagram of an illustrative data table corresponding to a merchant, in accordance with an embodiment of the invention;

FIG. 3a is a flow diagram of an illustrative method for contracting with purchasers, in accordance with an embodiment of the invention;

FIG. 3b is a diagram of an illustrative data table corresponding to a purchaser, in accordance with an embodiment of the invention;

FIG. 4a is a flow diagram of an illustrative method for receiving transaction information, in accordance with an embodiment of the invention;

FIG. 4b is a diagram of an illustrative data table for storing transaction information, in accordance with an embodiment of the invention;

FIG. 5a is a flow diagram of an illustrative method for determining a donation amount, in accordance with an embodiment of the invention; and

FIG. 5b is a diagram of an illustrative data table for donation amounts, in accordance with an embodiment of the invention.

### DETAILED DESCRIPTION OF ILLUSTRATIVE EMBODIMENTS

The invention is directed to a system and method wherein a purchaser selects a beneficiary and a merchant predefines a donation percentage. The selected beneficiary and the predefined donation percentage are received by a processor. The purchaser's transaction amount is tracked and the predefined donation percentage of the transaction amount (i.e., the donation amount) is donated from the merchant to the beneficiary. The system of in invention provides an accounting of this information.

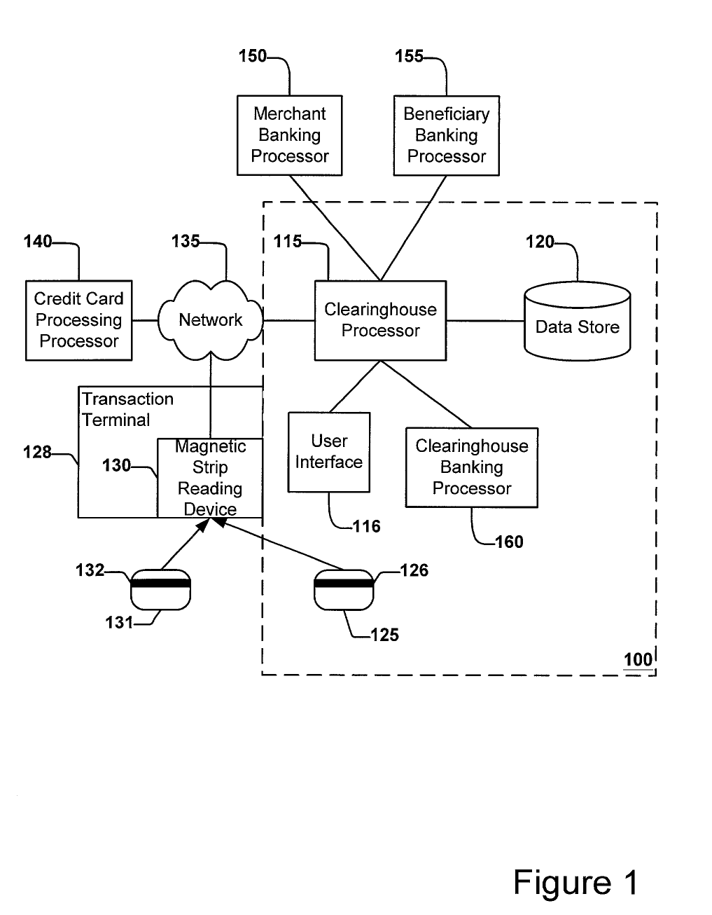

FIG. 1 shows an illustrative system 100 in accordance with an embodiment of the invention. As shown in FIG. 1, system 100 includes a clearinghouse processor 115 having a user interface 116, a data store 120, a donation program card 125, and a clearinghouse banking processor 160.

Clearinghouse processor 115 operates to receive transaction information, purchaser information, and merchant information, and to determine a donation amount based on the transaction information, the purchaser information, and the merchant information, as described in more detail below. The term merchant is defined herein to include providers of services as well as providers of goods. Clearinghouse processor 115 may further cause an electronic transfer of funds (e.g., in the amount of the determined donation amount) to be performed.

Clearinghouse processor 115 may use a portion of the existing credit card system. In the operation of the existing credit card system, a merchant (or a purchaser) “swipes” a credit card 131 through a magnetic strip reading device 130 of a transaction terminal 128. Credit card 131 has a magnetic strip 132 with information encoded thereon, such as, for example, an account number, an identification of a credit provider, and the like. Transaction terminal 128 activates a communication link through network 135 (e.g., through a phone line) to a credit card processing processor 140 corresponding to the credit provider identified on magnetic strip 132 of credit card 131. Transaction terminal requests authorization for a purchase. An example of a transaction terminal 128 is credit card reader that uses conventional magnetic strip reading technology and is installed in over four million sites nationwide.

Clearinghouse processor 115 communicates with transaction terminal 128 via network 135 to receive transaction information. In this manner, the present invention can make use of a large existing infrastructure of credit card readers and can therefore be implemented at a reduced cost.

Rather than reading credit card 131, in the present invention, transaction terminal 128 reads information from a donation program card 125. Donation program card 125 includes a magnetic strip 126 with information encoded thereon. The information on donation program card 125 card data includes a card type identification that identifies the card as a donation program card (rather than a credit card) and is used by transaction terminal 128 to select a processor for communication. That is, when transaction terminal 128 determines that the card being “swiped” is donation program card 125, transaction terminal 128 selects clearinghouse processor 115 for communication rather than credit card processing processor 140. Typically, magnetic strip 126 of donation program card 125 contains a card holder, but does not contains a value amount. In this embodiment, donation program card 125 is used to identify the card holder rather than to identify an amount of funds encoded on the card 125. In this embodiment, donation program card 125 has no monetary value and cannot be used to purchase goods, for example, if card 125 is stolen.

The information on donation program card 125 also includes a donation program card holder identification. The donation program card holder identification may be a unique number that can be mapped to a purchaser. Alternatively, the donation program card holder identification may be purchaser identification, such as for example, a social security number, a purchaser name, and the like. In this manner, clearinghouse processor 115 can determine which purchaser information to use in determining a donation amount.

In addition to receiving information from donation program card 125, clearinghouse processor 115 receives transaction information, such as, for example, a purchase amount, a description of goods or services purchased, a SIC code of goods or services purchased, an indication of a merchant where the goods or services were purchased, and the like. Donation program card information and transaction information are received at clearinghouse processor 115 and are used to determine a donation amount.

Clearinghouse processor 115 further communicates with user interface 116, clearinghouse banking processor 160, data store 120, merchant banking processor 150, and beneficiary banking processor 155.

User interface 116 may include a keyboard, a mouse, a display monitor, and the like. Clearinghouse processor 115 may receive information from user interface 116, such as, for example, purchaser information and merchant information. Such purchaser information and merchant information may be used by clearinghouse processor 115 to determine a donation amount, as described in more detail below.

In order to facilitate crediting of accounts and electronic transfer of funds, clearinghouse processor 115 may communicate with merchant banking processor 150, beneficiary banking processor 155, and clearinghouse banking processor 160, as described in more detail below.

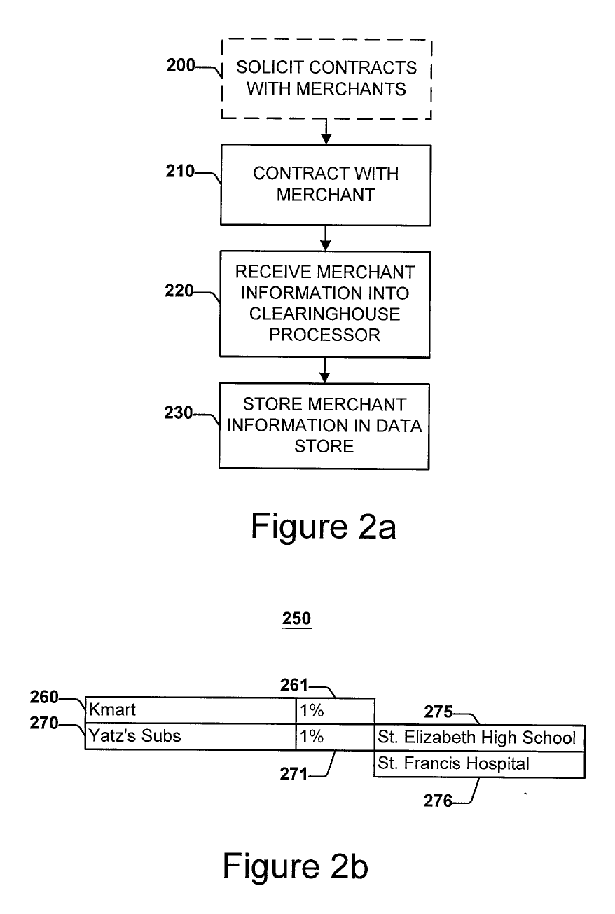

Purchasers and merchants typically contract with a donation program service provider to implement a donation card program. Upon contracting, purchaser information and merchant information are received into clearinghouse processor 115. FIG. 2 is a flow diagram of an illustrative method for receiving merchant information.

As shown in FIG. 2 at step 200, the donation program service provider solicits contracts with merchants. Contracts may be solicited by direct marketing, advertising, or the like. Alternatively, rather than the donation program service provider soliciting a contract, a merchant may approach the donation program service provider.

At step 210, a contract is formed with a merchant. The merchant selects a donation percentage to be donated to charity. The merchant agrees to allow donation program card 125 to be swiped at the point of sale, thereby allowing clearinghouse processor 115 to track transactions and to determine beneficiaries and donation amounts, as described in more detail below.

At step 220, merchant information is received into clearinghouse processor 115. Merchant information includes a merchant identification, such as, for example, a merchant name, a unique number identifying a merchant, an address, a phone number, a representative's name, and the like. Merchant information also includes a donation percentage that represents a percentage of donation program card transactions that are donated to charity.

Merchant information may further include beneficiary identification such as, for example, and a beneficiary name, a unique number identifying a beneficiary, an address, a phone number, a representative's name, and the like. Each beneficiary identification may have a corresponding donation percentage. For example, merchant information may include a beneficiary identification representing a school and a corresponding donation percentage of 2%, in which case, 2% of sales using a donation program card identifying the school is donated to the school. Merchant information may also include merchant banking information, such as, for example, a checking account number, a savings account number, and the like. Such merchant banking information may be used to facilitate crediting a beneficiary account or electronically transferring funds from a merchant account to a beneficiary account. Merchant information may be received from user interface 116.

At step 230, clearinghouse processor 115 stores merchant information in data store 120. FIG. 2b is an illustrative data table for storing merchant information. While a data table is illustrated, any appropriate storage structure to map from a merchant to a donation percentage may be used, such as, for example, a spreadsheet, an object oriented database, a relational database, and the like.

As shown in FIG. 2b, data table 250 includes a set of first fields 260, 270 for containing merchant identifications. Each first field 260, 270 has a corresponding second field 261, 271, respectively, for containing a donation percentage corresponding to each merchant. Data table may include a third set of fields 275, 276 for containing beneficiary information. With such beneficiary information, a merchant may limit which charities the donations go to. In this manner, a merchant may avoid contributing to a charity that it deems unsavory.

As illustrated, first field 260 contains the name “Kmart” as a merchant identification and a corresponding second field 261 contains “1%” representing that Kmart will donate 1% of sales using a donation program card to charity. Second field 270 contains the name “Yatz's Subs” as a merchant identification and a corresponding second field 271 contains “1%” representing that Yatz's Subs will donate 1% of sales using a donation program card to charity. First field 270 also has corresponding third fields 275 and 276 that contain beneficiary identifications “St. Elizabeth High School” and “St. Frances Hospital,” respectively. As such, Yatz's Subs has designated St. Elizabeth High School and St. Frances Hospital as acceptable beneficiaries.

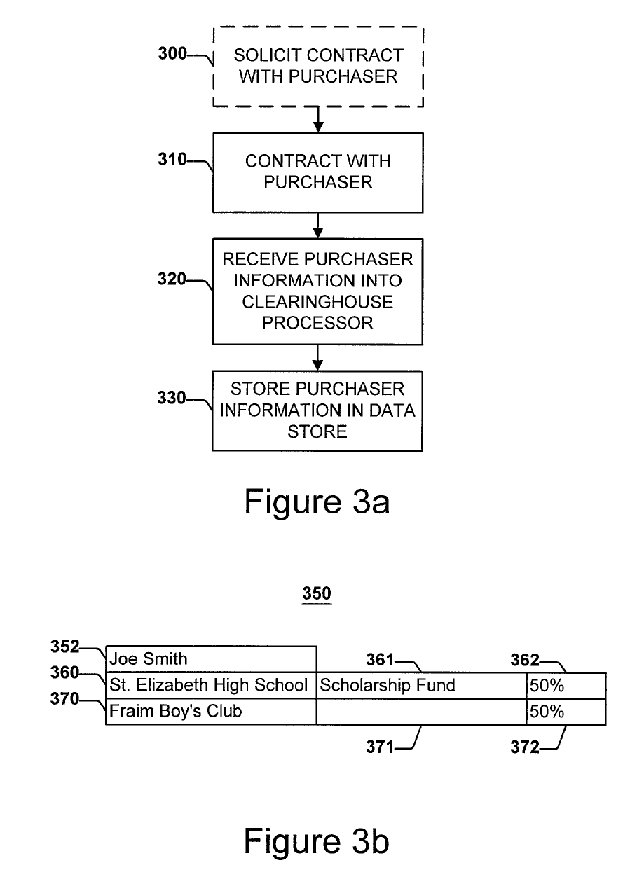

Rather than a merchant selecting which beneficiary receives a donation, in the present invention, the purchaser can select a beneficiary. As such, purchaser information, including the purchaser's selected beneficiary, is also received into clearinghouse processor 115. FIG. 3a is a flow diagram of an illustrative method for receiving purchaser information.

As shown in FIG. 3a at step 300, the donation program service provider solicits contracts with the purchaser. Contracts may be solicited by direct marketing, advertising, or the like. Alternatively, rather than the donation program service provider soliciting a contract, a purchaser may approach the donation program service provider.

At step 310, a contract is formed with a purchaser. The contract may be any type of contract: oral, written, implied, and the like. The purchaser selects a beneficiary to receive donations made by a merchant. As an example, Kmart may donate 1% of all sales to charity and a purchaser may select that donations resulting from their donation program card transactions go to a local high school. In this manner, a purchaser can select the beneficiary and the merchant can publicize that it supports the local school, thereby potentially increasing its goodwill in the community.

At step 320, purchaser information (e.g., a beneficiary selection) is received into clearinghouse processor 115. Purchaser information includes a purchaser identification and a beneficiary identification. Purchaser identification may include a purchaser's name and address, the donation program card number of the purchaser, and the like.

Beneficiary identification identifies one or more beneficiaries. Moreover, each beneficiary identification may include a corresponding sub-beneficiary identification. For example, if beneficiary identification represents a school, then sub-beneficiary identification may represent the music program, the athletic program, and the like. In the case of multiple beneficiaries or multiple sub-beneficiaries, beneficiary allocation information is included. For example, if a school and a youth organization are identified as beneficiaries, beneficiary allocation information may represent that 50% of a purchase is allocated to the school and 50% is allocated to the youth organization.

At step 330, clearinghouse processor 115 stores purchaser information in data store 120. FIG. 3b is an illustrative data table for storing such purchaser information. While a data table is illustrated, any appropriate storage structure to map from a purchaser to a beneficiary may be used, such as, for example, a spreadsheet, an object oriented database, a relational database, and the like.

As shown in FIG. 3b, data table 350 includes a first field 352 for containing a purchaser identification and associated fields 360-372 for containing the purchaser's beneficiary information. First field 352 contains the name “Joe Smith” as a purchaser identification. Field 360 contains “St. Elizabeth High School” and field 370 contains “Fraim Boy's Club” representing that Joe Smith has designated St. Elizabeth High School and Fraim Boy's Club as beneficiaries. Field 361 contains “Scholarship Fund” representing that Joe Smith has designated the Scholarship Fund of St. Elizabeth High School as a beneficiary. Field 371 contains no information, representing that Joe Smith has not designated a sub-beneficiary for the donation to Fraim Boy's Club (i.e., Fraim Boy's Club chooses how to spend the donation). Field 362 contains “50%” representing that Joe Smith has designated that St. Elizabeth High School receive 50% of the donation amount. Field 372 contains “50%” representing that Joe Smith has designated that Fraim Boy's Club receive 50% of the donation amount.

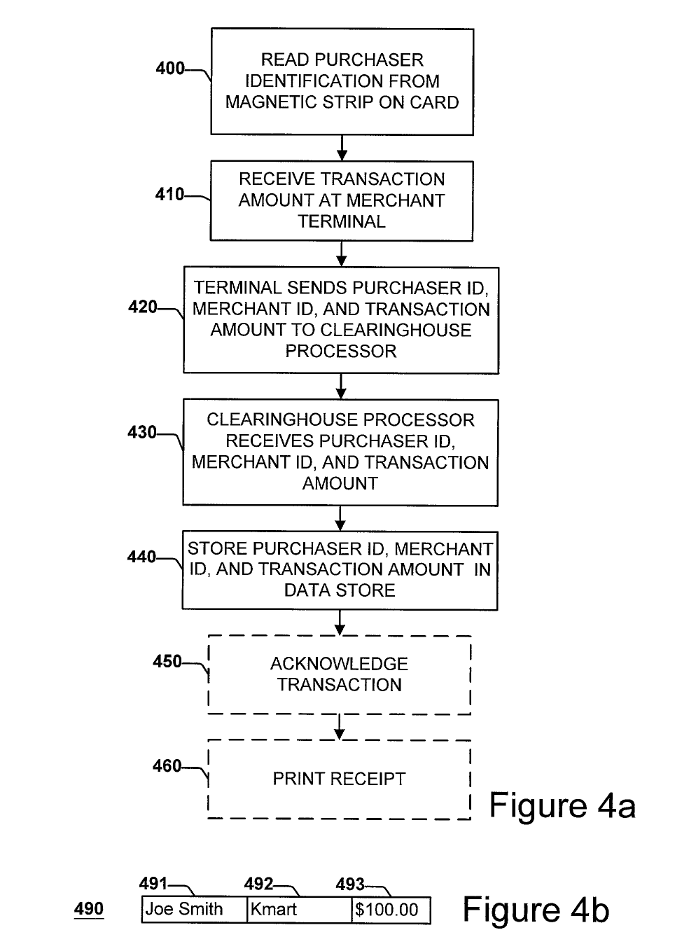

With the received merchant and purchaser information, upon receiving transaction information, clearinghouse computer 115 can determine a beneficiary and a donation amount, a method of which is illustrated in FIG. 4a. The following description of FIG. 4a contemplates the method being performed on the system of FIG. 1, however, the invention may be implemented on a variety of systems.

As shown in FIG. 4a at step 400, magnetic strip reading device 130 reads card information from magnetic strip 126 of donation program card 125. Donation program card 125 is typically swiped through magnetic strip reading device 130 during a purchase of goods or services. The card information is received by terminal 128. Alternatively, the card information may be manually entered into terminal 128 via a keypad (not shown), read from a bar code, read from a smart chip, a Schlage card, or the like.

At step 410, purchase information is received by terminal 128. Purchase information includes the purchase amount of the transaction. The purchase amount may be entered into a keypad on terminal 128, read from another processor, for example, an electronic cash register, or the like. The purchase amount may correspond to any type of payment, for example, cash, credit, check, debit, or the like. Purchase information may further include other information such as, for example, a description of goods and services purchased, a SIC code of goods and services purchased, a store identification, a merchant identification, and the like.

At step 420, terminal 128 sends the card information and the transaction information to clearinghouse processor 115 via network 135. The card information includes the purchaser identification and the transaction information includes the amount spent during the transaction and an identification of the merchant.

At step 430, clearinghouse processor 115 receives the card information and the transaction information.

At step 440, clearinghouse processor 115 stores the received card information, merchant information, and transaction information in data store 120.

FIG. 4b shows an illustrative data table that may be used to store received card and transaction information. While a data table is illustrated, any appropriate storage structure to map from a purchaser to a beneficiary may be used, such as, for example, a spreadsheet, an object oriented database, a relational database, and the like. The following description also contemplates Joe Smith purchasing a tool for $100.00 at Kmart and the illustrative data tables of FIGS. 2b and 3b. As shown in FIG. 4b, data table 490 includes a first field 491 for containing a purchaser identification, a second field 492 for containing a merchant identification, and a third field 493 for containing a transaction amount. As shown, first field 491 contains “Joe Smith,” second field 492 contains “Kmart,” and third field 493 contains “$100.00” representing that Joe Smith made a $100.00 transaction at Kmart.

Multiple transactions can be stored in such a data table. In this manner, clearinghouse processor 115 can determine donation amounts in a batch process. That is, clearinghouse processor 115 can read information corresponding to multiple transactions at some interval (e.g., once a week) and determine donation amounts for each beneficiary and charity amounts for each merchant. Alternatively, clearinghouse processor 155 may determine a donation amount upon each receipt of card information and transaction information and keep a running tally of donation amounts and charity amounts.

At optional step 450, clearinghouse processor 115 sends an acknowledgement to terminal 128 via network 135.

At optional step 460, terminal 128 prints a receipt including the amount of the purchase, the amount of funds donated, and the beneficiary.

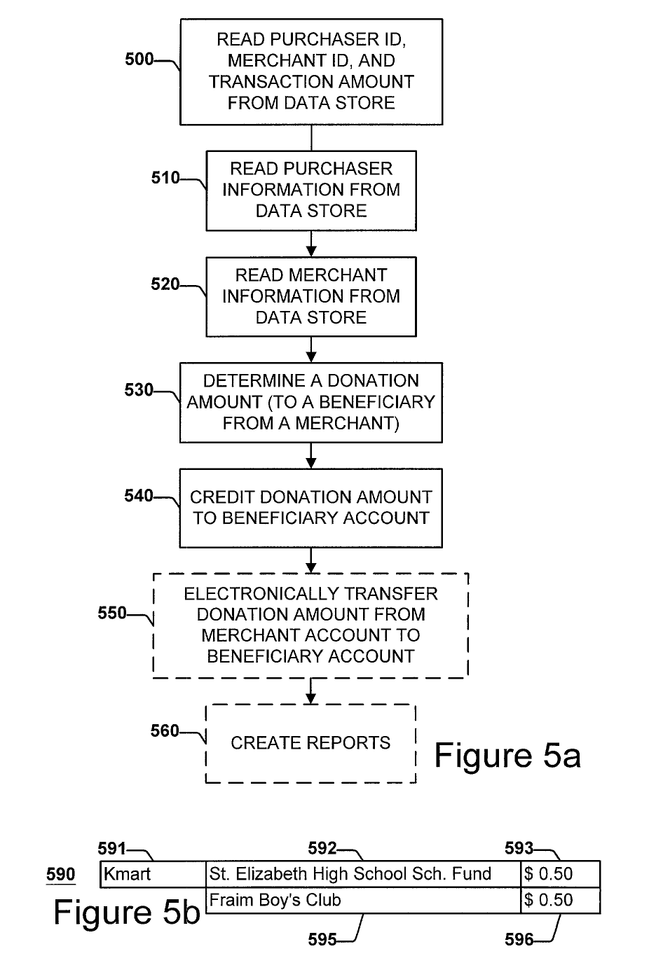

FIG. 5a is a flow diagram of an illustrative method for determining a donation amount, in accordance with an embodiment of the invention. The following description of FIG. 5a contemplates the method being performed on the system of FIG. 1, however, the invention may be implemented on a variety of systems.

As shown in FIG. 5a at step 500, clearinghouse processor 115 reads a purchaser identification, a merchant identification, and a transaction amount from data store 120. For example, clearinghouse processor 115 reads “Joe Smith,” “Kmart,” and “$100.00” from data store 120. Such information may have been stored in data store 120 in a method such as described in FIG. 4a and in the data table of FIG. 4b. With such an implementation using data store 120, donation amounts may be determined in a batch process. Alternatively, clearinghouse processor 115 may receive such purchaser identification, merchant identification, and a transaction amount from terminal 128 without storing such information.

At step 510, clearinghouse processor 115 reads purchaser information from data store 120 to determine a beneficiary associated with the purchaser identification. If there are more than one beneficiary, then clearinghouse processor 115 reads allocation information corresponding to the beneficiaries. Additionally, if there are sub-beneficiaries, then clearinghouse processor 115 reads the sub-beneficiary allocation information corresponding to the sub-beneficiary. For example, after clearinghouse processor 115 reads “Joe Smith” from data table 450, clearinghouse processor 115 searches data table 350 for “Joe Smith.” Upon finding “Joe Smith” in data table 350, clearinghouse processor 115 reads the beneficiary identifications corresponding to “Joe Smith.” In particular, clearinghouse processor 115 determines that Joe Smith has selected that 50% of donation program card donation funds goes to St. Elizabeth High School Scholarship Fund and that 50% goes to Fraim Boy's Club.

At step 520, clearinghouse processor 115 reads merchant information from data store 120 to determine a donation percentage. Further, if the merchant information includes acceptable beneficiaries, clearinghouse processor 115 reads the acceptable beneficiaries. For example, after clearinghouse processor 115 reads “Kmart” from data table 450, clearinghouse processor 115 searches data table 250 for “Kmart.” Upon finding “Joe Smith” in data table 250, clearinghouse processor 115 reads the donation amount corresponding to “Kmart.” In particular, clearinghouse processor 115 reads from data table 250 that Kmart has predefined a donation percentage of 1% of the transaction amount.

At step 530, clearinghouse processor 115 determines a donation amount. The donation amount is based on the transaction amount and the donation percentage defined by the merchant. If there are more than one beneficiary, then the donation amount also depends on the allocation information corresponding to the beneficiaries. If there are sub-beneficiaries, then the donation amount also depends on the allocation information corresponding to the sub-beneficiary identifications. For example, clearinghouse processor 115 determines that 1% of the $100.00transaction amount is $1.00.Clearinghouse processor 115 further determines that 50% goes to St. Elizabeth High School Scholarship Fund (i.e., 50 cents) and that 50% (i.e., 50 cents) goes to Fraim Boy's Club.

Clearinghouse processor 115 may further store the determined donation amount. FIG. 5b is an illustrative data table for storing purchaser information for this purpose. While a data table is illustrated, any appropriate storage structure to map from a purchaser to a beneficiary may be used, such as, for example, a spreadsheet, an object oriented database, a relational database, and the like. As shown in FIG. 5b, data table 590 includes a first field 591 for containing a merchant identification and associated fields 592-596 for containing a beneficiary identification and corresponding donation amount. First field 591 contains the merchant identification “Kmart” . Field 592 contains “St. Elizabeth High School Scholarship Fund” and corresponding field 593 contains “$0.50” representing that Kmart is donating $0.50 to St. Elizabeth High School Scholarship Fund. Field 595 contains “Fraim Boy's Club” and corresponding field 596 contains “$0.50” representing that Kmart is donating $0.50 to Fraim Boy's Club.

At step 540, clearinghouse processor 115 credits the donation amount to the beneficiary account. Clearinghouse processor 115 may initiate such crediting at beneficiary banking processor 155, may cause clearinghouse banking processor 160 to initiate such crediting, or alternatively may retain a donation amount total in data store 120 for later crediting.

Alternatively, clearinghouse processor 115 may determine that no donation amount is to be credited. For example, if the merchant has selected acceptable beneficiaries and the beneficiary selected by the purchaser matches at least one of the acceptable beneficiaries, then the amount is credited. However, if the beneficiary selected by the purchaser does not match any of the acceptable beneficiaries, then the amount is not credited.

At optional step 550, clearinghouse processor 115 causes merchant banking processor 150 to electronically transfer funds (e.g., in the amount of the donation amount) to beneficiary banking processor 155. Typically, funds are transferred from merchant banking processor 150 to clearinghouse banking processor 160 and from clearinghouse banking processor 160 to beneficiary banking processor 155. With such a transfer technique, clearinghouse banking processor 160 retains a pool of funds. In this manner, donation program service provider may access a percentage of the donation funds to pay for providing such service. Typically, clearinghouse banking processor 160 transfers funds once per day, representing all transactions for that day. Alternatively, funds may be transferred at any other interval, for example, weekly, monthly, or the like.

At optional step 560, clearinghouse processor 115 creates reports that summarize donation amounts for purchasers, merchants, and/or beneficiaries.

In another embodiment, at step 550, funds may be sent to a beneficiary by check, for example.

As described above, the invention improves the existing fundraising system. The purchaser no longer needs to pre-pay large amounts of money for paper certificates at a limited number of merchants. The invention also eliminates the beneficiary's accounting of individual participation in certificate purchases and removes the guesswork of trying to determine the desired merchant locations and spending habits of purchasers.

Purchasers may use the donation program card at all participating merchants, at a moments notice, without the need to pre-plan or pre-pay for certificates. Purchasers may use any form of payment at a participating merchant rather than the time consuming use of low denomination gift certificates. The entire value of the sale is recorded and achieves the full benefit of the merchant's percentage donation amount. Many times paper certificates were used only for a portion of the purchase amount; therefore, beneficiaries did not receive the full benefit of the purchases. For example, if a purchaser bought a $50 dollar paper script, but purchased $90 worth of product or services from the merchant (i.e., the remaining $40 was paid for in cash), the beneficiary does not receive a percentage of the $40. Purchasers also have the opportunity to have family and friends use a card that will credit the merchant's donation directly to the purchaser's personal account.

The invention may be embodied in the form of program code (i.e., instructions) stored on a processor-readable medium, such as a magnetic, electrical, or optical storage medium, including without limitation a floppy diskette, CD-ROM, CD-RW, DVD-ROM, DVD-RAM, magnetic tape, flash memory, hard disk drive, or any other machine-readable storage medium, wherein, when the program code is loaded into and executed by a machine, such as a processor, the machine becomes an apparatus for practicing the invention. The invention may also be embodied in the form of program code that is transmitted over a transmission medium, such as electrical wiring or cabling, through fiber optics, over a network, including the Internet or an intranet, or via any other form of transmission, wherein, when the program code is received and loaded into and executed by a machine, such as a processor, the machine becomes an apparatus for practicing the invention. When implemented on a general-purpose processor, the program code combines with the processor to provide a unique apparatus that operates analogously to specific logic circuits.

It is to be understood that the foregoing examples have been provided merely for the purpose of explanation and are in no way to be construed as limiting of the invention. While the invention has been described with reference to exemplary embodiments, it is understood that the words which have been used herein are words of description and illustration, rather than words of limitations. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

What is claimed is:

1. A method for fundraising, comprising:
receiving a transaction purchase amount from a merchant;
determining a donation amount based on the received transaction purchase amount and a predefined donation percentage for the merchant; and
crediting the determined donation amount to an account of a beneficiary.

2. The method as recited in claim 1, wherein the step of receiving a transaction purchase amount comprises receiving, from a point of sale location, a transaction purchase amount and a purchaser identification.

3. The method as recited in claim 2, wherein the step of receiving a transaction purchase amount and a purchaser identification comprises receiving a purchaser identification from one of a magnetic strip reading device, a bar code scanner, and a keypad.

4. The method as recited in claim 1, wherein the step of determining a donation amount comprises:
determining a first donation amount for a first beneficiary based on the received transaction purchase amount, the predefined donation percentage, and a first percentage representing a percentage corresponding to the first beneficiary; and
determining a second donation amount for a second beneficiary based on the received transaction purchase amount, the predefined donation percentage, and a second percentage representing a percentage corresponding to the second beneficiary.

5. The method as recited in claim 4, wherein the step of crediting comprises crediting the first donation amount to an account of the first beneficiary and the second donation amount to an account of the second beneficiary.

6. The method as recited in claim 1, further comprising the step of electronically transferring the donation amount of funds to the beneficiary account.

7. The method as recited in claim 1, further comprising the step of storing a purchaser identification and a corresponding beneficiary identification.

8. The method as recited in claim 7, wherein the step of storing a purchaser identification and a corresponding beneficiary identification comprises storing a first beneficiary identification and a corresponding first percentage and storing a second beneficiary identification and a corresponding second percentage.

9. The method as recited in claim 1, further comprising the step of storing a donation percentage associated with a merchant.

10. The method as recited in claim 7, further comprising the step of storing a merchant identification and a corresponding plurality of beneficiary identifications acceptable to the merchant.

11. The method as recited in claim 10, wherein the step of crediting comprises crediting, if the beneficiary identification corresponding to the purchaser identification matches at least one of the plurality of beneficiary identifications corresponding to the merchant identification.

12. The method as recited in claim 1, further comprising the step of storing the transaction purchase amount, the donation amount, and a beneficiary identification to a data store.

13. The method as recited in claim 1, further comprising the steps of preparing a report and reporting the purchase amount, the donation amount, and a beneficiary identification.

14. The method as recited in claim 1, further comprising the step of selecting, by a purchaser associated with the transaction purchase amount, the beneficiary.

15. The method as recited in claim 1, wherein:
the step of receiving a transaction purchase amount comprises receiving a plurality of transaction purchase amounts and storing the transaction purchase amounts; and
the step of determining a donation amount comprises determining, in a batch process, a donation amount based on the received plurality of transaction purchase amounts and a predefined donation percentage for said merchant.

16. A method for fundraising, comprising:
contracting with a merchant to donate a redefined percentage of transaction proceeds;
storing an identification of the merchant and the predefined percentage on a data store;
contracting with a purchaser that selects a beneficiary for receiving at least a portion of the merchant donation;
storing an identification of the purchaser and an identification of the selected beneficiary on a data store; and storing an identification of the purchaser on a card.

17. The method as recited in claim 16, wherein the step of storing an identification of the purchaser and an identification of the selected beneficiary comprises storing an identification of a first beneficiary and a corresponding first percentage and an identification of a second beneficiary and a corresponding second percentage.

18. The method as recited in claim 16, wherein the step of storing an identification of the purchaser comprises storing an identification of the purchaser on a magnetic strip on a donation program card.

19. The method as recited in claim 16, wherein the step of storing an identification of the purchaser comprises storing a purchaser name on a card.

20. The method as recited in claim 16, wherein the step of storing an identification of the purchaser comprises storing a number corresponding to a purchaser on a card.

21. A system for fundraising, comprising:
a data store for storing a merchant identification, a predefined donation percentage corresponding to the merchant, a purchaser identification, and a beneficiary identification corresponding to the purchaser; and
a processor in communication with the data store and in communication with a merchant transaction device, the processor receiving a transaction purchase amount from a merchant, determining a donation amount based on the received transaction purchase amount and the predefined donation percentage for the merchant, and crediting the determined donation amount to an account of a beneficiary.

22. The system as recited in claim 21, further comprising a card comprising a data store for containing a card identification corresponding to the purchaser identification.

23. The system as recited in claim 22, wherein data store comprises a magnetic strip.

24. The system as recited in claim 22, wherein the data store comprises a bar code.
